(19) United States
(12) Patent Application Publication
(10) Pub. No.: US 2013/0293949 A1
(43) Pub. Date: Nov. 7, 2013

(54) ADHESIVE COMPOSITION CURABLE WITH ACTIVE ENERGY RAY, POLARIZING PLATE, OPTICAL FILM, AND IMAGE DISPLAY DEVICE

(71) Applicants: Takeshi Saito, Ibaraki-shi (JP); Masashi Shinagawa, Ibaraki-shi (JP); Tetsurou Ikeda, Ibaraki-shi (JP); Tatsuya Yamasaki, Ibaraki-shi (JP); Toshiki Oomine, Ibaraki-shi (JP); Masayuki Satake, Ibaraki-shi (JP); Shusaku Goto, Ibaraki-shi (JP); Takeharu Kitagawa, Ibaraki-shi (JP); Minoru Miyatake, Ibaraki-shi (JP); Tomohiro Mori, Ibaraki-shi (JP); Takashi Kamijo, Ibaraki-shi (JP)

(72) Inventors: Takeshi Saito, Ibaraki-shi (JP); Masashi Shinagawa, Ibaraki-shi (JP); Tetsurou Ikeda, Ibaraki-shi (JP); Tatsuya Yamasaki, Ibaraki-shi (JP); Toshiki Oomine, Ibaraki-shi (JP); Masayuki Satake, Ibaraki-shi (JP); Shusaku Goto, Ibaraki-shi (JP); Takeharu Kitagawa, Ibaraki-shi (JP); Minoru Miyatake, Ibaraki-shi (JP); Tomohiro Mori, Ibaraki-shi (JP); Takashi Kamijo, Ibaraki-shi (JP)

(73) Assignee: NITTO DENKO CORPORATION, Ibaraki-shi, Osaka (JP)

(21) Appl. No.: 13/996,911

(22) PCT Filed: Dec. 13, 2011
(86) PCT No.: PCT/JP2011/078772

§ 371 Date: Jun. 21, 2013

(30) Foreign Application Priority Data
Dec. 24, 2010 (JP) 2010-288155
May 30, 2011 (JP) 2011-120503

(51) Int. Cl. G02B 1/10

(52) U.S. Cl. CPC G02B 1/105
USPC 359/352; 524/850; 522/53; 522/16

(57) ABSTRACT

An adhesive composition curable with an active energy ray includes radical polymerizable compounds (A), (B) and (C) as curable components. The composition includes the radical polymerizable compound (A) having an SP value of 29.0 to 32.0 (kJ/m³)^{1/2} both inclusive in a proportion of 20 to 60% by weight, the radical polymerizable compound (B) having an SP value of 18.0 (kJ/m³)^{1/2} or more, and less than 21.0 (kJ/m³)^{1/2} in a proportion of 10 to 30% by weight, and the radical polymerizable compound (C) having an SP value of 21.0 to 23.0 (kJ/m³)^{1/2} both inclusive in a proportion of 20 to 60% by weight, when the total amount of the adhesive composition is regarded as 100% by weight, and a homopolymer made from each of the radical polymerizable compounds (A), (B) and (C) has a glass transition temperature (Tg) of 60° C. or higher.

### TECHNICAL FIELD

The present invention relates to an adhesive composition curable with an active energy ray, or active-energy-ray-curable adhesive composition, that forms an adhesive layer for bonding two or more members to each other, particularly, an adhesive composition curable with an active energy ray that forms an adhesive layer for a polarizer and a transparent protective film; and a polarizing plate. This polarizing plate can form, alone or in the form of an optical film wherein a polarizing plate(s) is(are) laminated, an image display device, such as a liquid crystal display device (LCD), an organic EL display device, a CRT or a PDP.

### BACKGROUND ART

Liquid crystal display devices have been rapidly spreading in the markets of clocks, portable telephones, PDAs, notebook-sized personal computers, monitors for personal computers, DVD players, TVs and others. Any liquid crystal display device is a device in which a polarization state based on the switching of liquid crystal is made visible. On the basis of the display principle thereof, a polarizer is used. In particular, for TVs and others, a high brightness, a high contrast and a wide viewing angle have been increasingly desired. Thus, also for their polarizing plates, a high transmittance, a high polarization degree and a high color reproducibility have been increasingly desired.

As a polarizer, an iodine-contained polarizer has been most popularly used which has, for example, a structure obtained by adsorbing iodine onto a polyvinyl alcohol (hereinafter, also referred to merely as “PVA”) and then drawing the workpiece since the iodine-contained polarizer has a high transmittance, and a high polarization degree. A generally used polarizing plate is one obtained by bonding transparent protective films onto both surfaces of a polarizer, respectively, through the so-called water-based adhesive, in which a polyvinyl alcohol type material is dissolved in water (Patent Documents 1 and 2 listed below). For the transparent protective films, triacetylcellulose or the like, which is high in moisture permeability, is used.

In the case of using a water-based adhesive such as a polyvinyl alcohol type adhesive (so-called wet-lamination) when a polarizing plate is produced, a drying step is required after a polarizer is bonded to transparent protective films. In order to improve polarizing plates in productivity, it is desired to shorten the drying step, or adopt other bonding method requiring no drying step.

When a water-based adhesive is used, a polarizing plate good in adhesive property cannot be obtained unless the water content by percentage in its polarizer is also made relatively high (usually, the water content by percentage in a polarizer is about 30%) in order to enhance the adhesive property of the adhesive onto the polarizer. However, a polarizing plate obtained in such a way has problems of being large in dimension change at high temperature or at high temperature and high humidity, and being poor in optical properties, and other problems. Meanwhile, in order to restrain the dimension change, the water content by percentage in the polarizer may be lowered, or transparent protective films low in moisture permeability may be used. However, when such a polarizer is bonded to such transparent protective films through a water-based adhesive, the drying efficiency is lowered or the polarizer is declined in polarization property. Alternatively, an inconvenience into the external appearance is generated. Thus, a practically useful polarizing plate cannot be obtained.

In recent years, image display devices, typical examples of which are particularly TVs, have been increasing in screen size. With the increase, it has been becoming very important from the viewpoint of productivity and costs (increase in the yield ratio and the number of products manufactured per unit) to make the size of polarizing plates larger. However, the polarizing plate using a water-based adhesive as described above is subject to dimension change by heat from its backlight. The change causes unevenness to result in a problem of making the so-called pixel missing (unevenness) remarkable, the pixel missing being a phenomenon that black display in the whole of the screen partially looks white.

In order to solve the problem in the above-mentioned wet-lamination, suggested is an active-energy-ray-curable adhesive containing neither water nor any organic solvent. For example, Patent Document 3 listed below discloses an active-energy-ray-curable adhesive containing a radial polymerizable compound (A) having a polar group and a molecular weight of 1000 or less, a radical polymerizable compound (B) having no polar group and having a molecular weight of 1000 or less, and a photopolymerization initiator (D). However, the combination of the radical polymerizable compounds (monomers) constituting this adhesive is designed to improve the adhesive property thereof, particularly, onto a norbornene resin film. Thus, the combination tends to be poor in adhesive property onto polarizing films.

Patent Document 4 listed below discloses an active-energy-ray-curable adhesive containing, as essential components, a photopolymerization initiator having a molar extinction coefficient of 400 or more at a wavelength of 360 to 450 nm, and an ultraviolet-curable compound. However, the combination of the monomers constituting this adhesive is designed mainly to prevent an optical disc or some other article from being warped or deformed when bonded. Thus, when used for a polarizing film, the adhesive tends to be poor in adhesive property onto the polarizing film.

Patent Document 5 listed below discloses an active-energy-ray-curable adhesive containing a (meth)acryl-based compound (a) having in the molecule thereof two or more (meth)acryloyl groups, a (meth)acryl-based compound (b) having in the molecule thereof a hydroxyl group and only one polymerizable double bond, and a phenol ethylene oxide modified acrylate or nonyl phenol ethylene oxide modified acrylate (c) in 100 parts by weight of a total amount of the (meth)acryl-based compounds. However, about the combination of the monomers constituting this adhesive, the monomers are low in compatibility with each other so that a phase separation advances. Thus, for example, it is feared that a layer of the adhesive is lowered in transparency. This adhesive is one for being improved in adhesive property by softening a cured product (adhesive layer) (lowering the Tg thereof). Thus, it is feared that the adhesive layer is deteriorated in endurances such as crack resistance. The crack resistance can be evaluated by a thermal shock test (heat shock test).

The present inventors developed a radical polymerization type active-energy-ray-curable adhesive using an N-substituted amide monomer as a curable component (Patent Documents 6 and 7 listed below). This adhesive exhibits an excellent endurance in a severe environment having a high humidity and a high temperature. In the actual circumferences, however, the market has been requiring an adhesive further improvable in adhesive property and/or water resistance.

### PRIOR ART DOCUMENTS

### Patent Documents

Patent Document 1: JP-A-2006-220732
Patent Document 2: JP-A-2001-296427
Patent Document 3: JP-A-2008-009329
Patent Document 4: JP-A-09-31416
Patent Document 5: JP-A-2008-174667
Patent Document 6: JP-A-2008-287207
Patent Document 7: JP-A-2010-78700

### SUMMARY OF THE INVENTION

### Problems to be Solved by the Invention

The present invention has done in light of the above-mentioned actual situation, and an object thereof is to provide an active-energy-ray-curable adhesive composition capable of forming an adhesive layer which is improved in adhesion between two or more members, particularly, between a polarizer and a transparent protective film, and which is made better in endurance and water resistance; a polarizing plate; an optical film; and an image display device.

### Means for Solving the Problems

In order to solve the problems, the present inventors have paid attention to the respective SP values (solubility parameters) of curable components in an active-energy-ray-curable adhesive composition. It is generally said that substances near to each other in SP value are high in compatibility with each other. Accordingly, for example, when radical polymerizable compounds are near to each other in SP value, the compatibility between these compounds is heightened, and further when a radical polymerizable compound in an active-energy-ray-curable adhesive composition is near in SP value to a polarizer, adhesion between the adhesive layer and the polarizer is heightened. Similarly, when a radical polymerizable compound in an active-energy-ray-curable adhesive composition is near in SP value to a protective film (triacetylcellulose film (TAC), acryl-based film or cycloolefin film), adhesion is heightened between the adhesive layer and the protective film. On the basis of these tendencies, the inventors have made eager investigations to find out that the above-mentioned problems can be solved by designing, into specific ranges, the respective SP values of at least three radical polymerizable compounds in an active-energy-ray-curable adhesive composition, and further setting the composition ratio between the compounds into optimal ratio values. The present invention, which has been made by the above-mentioned investigations, attains the object by the following:

Thus, the active-energy-ray-curable adhesive composition according to the present invention is an adhesive composition curable with an active energy ray comprising radical polymerizable compounds (A), (B) and (C) as curable components. This composition comprises: the radical polymerizable compound (A) having an SP value of 29.0 to 32.0 (kJ/m³)^{1/2} both inclusive in a proportion of 20 to 60% by weight, the radical polymerizable compound (B) having an SP value of 18.0 (kJ/m³)^{1/2} or more, and less than 21.0 (kJ/m³)^{1/2} in a proportion of 10 to 30% by weight, and the radical polymerizable compound (C) having an SP value of 21.0 to 23.0 (kJ/m³)^{1/2} both inclusive in a proportion of 20 to 60% by weight, when the total amount of the composition is regarded as 100% by weight, wherein a homopolymer made from each of the radical polymerizable compounds (A), (B) and (C) has a glass transition temperature (Tg) of 60° C. or higher.

In the active-energy-ray-curable adhesive composition according to the present invention, the radical polymerizable compound (A) has an SP value of 29.0 to 32.0 (kJ/m³)^{1/2} both inclusive, and the composition proportion thereof is from 20 to 60% by weight, when the total amount of the composition is regarded as 100% by weight. This radical polymerizable compound (A) has the high SP value to contribute largely to an improvement in adhesion between the (resultant) adhesive layer and, for example, a PVA based polarizer (SP value: for example, 32.8), and between the adhesive layer and saponified triacetylcellulose (SP value: for example, 32.7) as a transparent protective film. However, the SP value of the radical polymerizable compound (A) is relatively near to that (47.9) of water; thus, if the composition proportion of the radical polymerizable compound (A) in the composition is too large, it is feared that the adhesive layer is deteriorated in water resistance. Accordingly, in the case of considering the adhesive property and the water resistance on the polarizer, the saponified triacetylcellulose and others, it is essential to set the composition proportion of the radical polymerizable compound (A) into the range of 20 to 60% by weight. In the case of considering the adhesive property, the composition proportion of the radical polymerizable compound (A) is set preferably to 25% by weight or more, more preferably to 30% by weight or more. In the case of considering the water resistance, the composition proportion of the radical polymerizable compound (A) is set preferably to 55% by weight or less, more preferably to 50% by weight or less.

The radical polymerizable compound (B) has an SP value of 18.0 (kJ/m³)^{1/2} or more, and less than 21.0 (kJ/m³)^{1/2}, and the composition proportion thereof is from 10 to 30% by weight. This radical polymerizable compound (A) has the low SP value, which is largely apart from the SP value (47.9) of water, to contribute largely to the water resistance of the adhesive layer. The SP value of the radical polymerizable compound (B) is near to, for example, that (for example, 18.6) of a cyclic polyolefin resin (for example, “ZEONOR (trade name)” manufactured by Zeon Corp.) as a transparent protective film so as to contribute also to an improvement in the adhesive property onto this transparent protective film. In order to improve the water resistance of the adhesive layer further, it is preferred to set the SP value of the radical polymerizable compound (B) to a value less than 20.0 (kJ/m³)^{1/2}. On the other hand, the radical polymerizable compound (B) is largely apart in SP value from the radical polymerizable compound (A); thus, if the composition proportion is too large, the balance in the compatibilities between the radical polymerizable compounds is broken so that a phase separation advances. With the advance, it is feared that the adhesive layer is deteriorated in transparency. Accordingly, in the case of considering the water resistance, and the transparency of the adhesive layer, it is essential to set the composition proportion of the radical polymerizable compound (B) into the range of 10 to 30% by weight. In the case of considering the water resistance, the composition proportion of the radical polymerizable compound (B) is set preferably to 10% by weight or more, more preferably to 15% by weight or more. In the case of considering the transparency of the adhesive layer, the composition proportion of the radical polymerizable compound (B) is set preferably to 25% by weight or less, more preferably to 20% by weight or less. The SP value thereof is preferably 19.0 (kJ/m³)^{1/2} or more.

The radical polymerizable compound (C) has an SP value of 21.0 (kJ/m³)^{1/2} or more, and less than 23.0 (kJ/m³)^{1/2}, and the composition proportion thereof is from 20 to 60% by weight. As described above, the radical polymerizable compound (A) is largely apart in SP value from the radical polymerizable compound (B) so that these are poor in compatibility with each other. However, the SP value of the radical polymerizable compound (C) is positioned between the SP value of the radical polymerizable compound (A) and that of the radical polymerizable compound (B); thus, by use of the radical polymerizable compound (C) together with the radical polymerizable compounds (A) and (B), the compatibility as the whole composition is improved with a good balance. Furthermore, the SP value of the radical polymerizable compound (C) is near to, for example, that (for example, 23.3) of non-saponified triacetylcellulose as a transparent protective film, and that (for example, 22.2) of an acryl-based film. Accordingly, the radical polymerizable compound (C) also contributes to an improvement in the adhesive property (of the adhesive layer) onto these transparent protective films. Thus, in order to improve the water resistance and the adhesive property with a good balance, it is essential that the composition proportion of the radical polymerizable compound (C) is from 20 to 60% by weight. In the case of considering the compatibility as the whole composition, and the adhesive property onto the transparent protective films, the composition proportion of the radical polymerizable compound (C) is preferably 25% by weight or more, more preferably 29% by weight or more. In the case of considering the water resistance, the composition proportion of the radical polymerizable compound (C) is preferably 55% by weight or less, more preferably 50% by weight or less.

The glass transition temperature (Tg) of a homopolymer made from each of the radical polymerizable compounds (A), (B) and (C) is 60° C. or higher. For this reason, the adhesive composition or an adhesive layer therefrom is made particularly good in endurance to be prevented from undergoing the generation of a “heat shock crack”. The wording “heat shock crack” means a phenomenon that when, for example, a polarizer is shrunken, the polarizer tears in the drawn direction thereof. In order to prevent this, it is important to restrain the expansion and the shrinkage of the polarizer in a heat shock temperature range (of −40 to 60° C.). The glass transition temperature (Tg) of the homopolymer made from each of the radical polymerizable compounds (A), (B) and (C) is 60° C. or higher as described above; thus, when the adhesive layer is formed, the Tg thereof also becomes high. As a result, a rapid change in the elastic modulus of the adhesive layer in the heat shock temperature range is suppressed to make it possible to decrease expansion force and shrinkage force acting on the polarizer. Thus, the generation of the heat shock crack can be prevented.

Hereinafter, a description will be made about a method for calculating each of the SP values (solubility parameters) in the present invention.

### (Method for Calculating the SP Value (Solubility Parameter))

In the present invention, the solubility parameter (SP value) of each of the radical polymerizable compounds, the polarizer, and the transparent protective film that may be of various types can each be gained according to a Fedors' calculating method [see “Polymer Eng. & Sci.”, vol. 14, No. 2 (1974), pp. 148-154], that is, the following expression:

$$δ = {[ \frac{{\sum }_{i} Δ ei}{{\sum }_{i} vi} ]}^{\frac{1}{2}} \qquad [ Math . 1 ]$$

wherein Δei is an evaporation energy at 25° C. that is assigned to each of the atoms or groups, and Δvi is a molar volume thereof at 25° C.

In the mathematical expression, specified numerical values given to the atoms or groups, which are main atoms or groups the number of which is i, are set into Δei as well as Δvi. Typical examples of the numerical value of Δe as well as Δv, given to an atom or a group are shown in Table 1 described below.

TABLE 1

| Atom or group | Δe (l/mol) | Δv (cm³/mol) |
|---|---|---|
| CH₃ | 4086 | 33.5 |
| C | 1465 | −19.2 |
| Phenyl | 31940 | 71.4 |
| Phenylene | 31940 | 52.4 |
| COOH | 27628 | 28.5 |
| CONH₂ | 41861 | 17.5 |
| NH₂ | 12558 | 19.2 |
| —N═ | 11721 | 5.0 |
| CN | 25535 | 24.0 |
| NO₂ (fatty acid) | 29302 | 24.0 |
| NO₃ (aromatic group) | 15363 | 32.0 |
| O | 3349 | 3.8 |
| OH | 29805 | 10.0 |
| S | 14149 | 12.0 |
| F | 4186 | 18.0 |
| Cl | 11553 | 24.0 |
| Br | 15488 | 30.0 |

In the active-energy-ray-curable adhesive composition, it is preferred that when the total amount of the radical polymerizable compounds in the active-energy-ray-curable adhesive composition is regarded as 100 parts by weight, the radical polymerizable compounds (A), (B) and (C) are comprised in a total amount of 85 to 100 parts by weight, and further a radical polymerizable compound (D) having an SP value more than 23.0 (kJ/m³)^{1/2} and less than 29.0 (kJ/m³)^{1/2} is comprised in an amount of 0 to 15 parts by weight. According to this structure, the proportion of the radical polymerizable compounds (A), (B) and (C) in the adhesive composition can be sufficiently ensured so that the adhesive layer can be improved in adhesive property and more largely improved in endurance and water resistance. In order to improve the adhesive property, the endurance and the water resistance with a better balance, the radical polymerizable compounds (A), (B) and (C) are comprised preferably in a total amount of 90 to 100 parts by weight, more preferably 95 to 100 parts by weight.

In the active-energy-ray-curable adhesive composition, the radical polymerizable compound (A) is preferably hydroxyethylacrylamide and/or N-methylolacrylamide. In the active-energy-ray-curable adhesive composition, the radical polymerizable compound (B) is preferably tripropylene glycol diacrylate. Furthermore, in the active-energy-ray-curable adhesive composition, the radical polymerizable compound (C) is preferably acryloylmorpholine and/or N-methoxymethylacrylamide. These structures each make it possible to improve the adhesive layer in adhesive property, endurance and water resistance with an even better balance.

The active-energy-ray-curable adhesive composition preferably comprises, as a photopolymerization initiator, a compound represented by the following general formula (1):

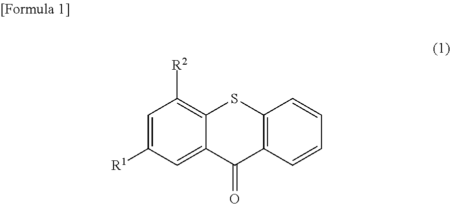

wherein R¹ and R² each represent —H, —CH₂CH₃, -iPr or Cl, and may be the same or different.

The photopolymerization initiator of the general formula (1) can initiate polymerization through a long-wavelength light ray transmissible into a transparent protective film having UV absorbing capability. Thus, UVs can cure the adhesive across a UV absorption film. Specifically, even in the case of laminating transparent protective films having UV absorption capability onto both surfaces of a polarizer, respectively, such as a triacetylcellulose/polarizer/triacetylcellulose form, the adhesive composition can be cured when the composition comprises the photopolymerization initiator of the general formula (1).

Preferably, the active-energy-ray-curable adhesive composition further comprises, as a photopolymerization initiator, a compound represented by the following general formula (2) in addition to the photopolymerization initiator of the general formula (1):

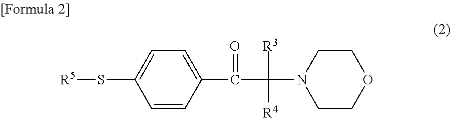

wherein R³, R⁴ and R⁵ each represent —H, —CH₃, —CH₂CH₃, -iPr or Cl, and may be the same or different. The use of the photopolymerization initiators of the general formulae (1) and (2) together makes, through photosensitization reactions thereof, the efficiency of the reaction high so that the adhesive property of the adhesive layer is particularly improved.

The polarizing plate according to the present invention is a polarizing plate including a polarizer, and a transparent protective film showing a transmittance less than 5% to a light ray having a wavelength of 365 nm and formed over at least one surface of the polarizer with an adhesive layer interposed between the polarizer and the transparent protective film, wherein the adhesive layer is formed by a cured product layer obtained by radiating an active energy ray to the active-energy-ray-curable adhesive composition described in any one of the paragraphs concerned.

As described above, polarizers are high in SP value (the SP value of a PVA based polarizer is, for example, 32.8) while transparent protective films are generally low in SP value (the SP value is from about 18 to 24). The polarizing plate according to the present invention is designed in such a manner that in its active-energy-ray-curable adhesive composition that forms an adhesive layer for bonding a polarizer with a high SP value onto one or more transparent protective films with a low SP value, the respective SP values and the respective blend proportions of radical polymerizable compounds (A), (B) and (C) are optimized. As a result, in such a polarizing plate, the polarizer and (each of) the transparent protective film(s) are strongly bonded onto each other through the adhesive layer, and further the adhesive layer is good in endurance and water resistance. When the Tg of the adhesive layer is, particularly, 60° C. or higher, more preferably 70° C. or higher, in particular preferably 90° C. or higher, the endurance is especially good so that the generation of a heat shock crack can be prevented.

The optical film according to the present invention is characterized in that at least one polarizing plate as described above is laminated.

In the polarizing plate, the SP value of the transparent protective film(s) is(are) preferably 29.0 (kJ/m³)^{1/2} or more, and less than 33.0 (kJ/m³)^{1/2}. When the SP value of the transparent protective film is within this range, this SP value is very near to that of the radical polymerizable compound (A) in the active-energy-ray-curable adhesive composition so that adhesion between the transparent protective film and the adhesive layer is largely improved. The transparent protective film having an SP value of 29.0 (kJ/m³)^{1/2} or more, and less than 33.0 (kJ/m³)^{1/2} is, for example, saponified triacetylcellulose (SP value: for example, 32.7).

In the polarizing plate, the SP value of the transparent protective film is preferably 18.0 (kJ/m³)^{1/2} or more, and less than 24.0 (kJ/m³)^{1/2}. When the SP value of the transparent protective film is within this range, this SP value is very near to that of each of the radical polymerizable compounds (B) and (C) in the active-energy-ray-curable adhesive composition, so that adhesion between the transparent protective film and the adhesive layer is largely improved. The transparent protective film having an SP value of 18.0 (kJ/m³)^{1/2} or more, and less than 24.0 (kJ/m³)^{1/2} is, for example, non-saponified triacetylcellulose (SP value: for example, 23.3).

Additionally, the image display device according to the present invention is an image display device, using the above-mentioned polarizing plate and/or the above-mentioned optical film. In the optical film and the image display device, the polarizer of the polarizing plate is strongly bonded onto (each of) the transparent protective film(s) thereof through the adhesive layer, and the adhesive layer is good in endurance and water resistance.

### Effect of the Invention

When a cured product of the active-energy-ray-curable adhesive composition according to the present invention is used to form an adhesive layer, an adhesive layer which is improved in adhesion between two or more members, particularly between a polarizer and a transparent protective film and which is improved in endurance and water resistance can be formed.

When a polarizing plate has an adhesive layer according to the present invention, a polarizing plate small in dimension change can be produced. Thus, the present invention can easily cope with an increase in the size of polarizing plates, and can restrain production costs of the polarizing plates from the viewpoint of the yield ratio thereof and the number of the polarizing plates manufactured per unit. Furthermore, the polarizing plate according to the present invention is good in dimension stability to make it possible to restrain the generation of unevenness in an image display device that is based on an external heat from its backlight.

### MODE FOR CARRYING OUT THE INVENTION

Any active-energy-ray-curable adhesive composition according to the present invention contains, as curable components, a radical polymerizable compound (A) having an SP value of 29.0 to 32.0 (kJ/m³)^{1/2} both inclusive in a proportion of 20 to 60% by weight, a radical polymerizable compound (B) having an SP value of 18.0 (kJ/m³)^{1/2} or more, and less than 21.0 (kJ/m³)^{1/2} in a proportion of 10 to 30% by weight, and a radical polymerizable compound (C) having an SP value of 21.0 to 23.0 (kJ/m³)^{1/2} both inclusive in a proportion of 20 to 60% by weight, when the total amount of the composition is regarded as 100% by weight. In the present invention, the “total amount of the composition” means the total amount of not only the radical polymerizable compounds but also various initiators and additives contained.

As long as a compound has a radical polymerizable group such as a (meth)acrylate group and an SP value of 29.0 to 32.0 (kJ/m³)^{1/2} both inclusive, any compound is usable as the radical polymerizable compound (A) without any limitation. Specific examples of the radical polymerizable compound (A) include hydroxyethylacrylamide (SP value: 29.6), and N-methylolacrylamide (SP value: 31.5). The wording “(meth)acrylate group” denotes an acrylate group and/or a methacrylate group.

As long as a compound has a radical polymerizable group such as a (meth)acrylate group and an SP value of 18.0 (kJ/m³)^{1/2} or more, and less than 21.0 (kJ/m³)^{1/2}, any compound is usable as the radical polymerizable compound (B) without any limitation. Specific examples of the radical polymerizable compound (B) include tripropylene glycol diacrylate (SP value: 19.0), 1,9-nonanediol diacrylate (SP value: 19.2), tricyclodecanedimethanol diacrylate (SP value: 20.3), cyclic trimethylolpropaneformal acrylate (SP value: 19.1), dioxane glycol diacrylate (SP value: 19.4), and EO-modified diglycerin tetraacrylate (SP value: 20.9). As the radical polymerizable compound (B), a commercially available product is also suitably usable. Examples thereof include ARONIX M-220 (manufactured by Toagosei Co., Ltd.; SP value: 9.0), LIGHT ACRYLATE 1,9ND-A (manufactured by Kyoeisha Chemical Co., Ltd.; SP value: 19.2), LIGHT ACRYLATE DGE-4A (manufactured by Kyoeisha Chemical Co., Ltd.; SP value: 20.9), LIGHT ACRYLATE DCP-A (manufactured by Kyoeisha Chemical Co., Ltd.; SP value: 20.3), SR-531 (manufactured by Sartomer Co.; SP value: 19.1), and CD-536 (manufactured by Sartomer Co.; SP value: 19.4).

As long as a compound has a radical polymerizable group such as a (meth)acrylate group and an SP value of 21.0 to 23.0 (kJ/m³)^{1/2} both inclusive, any compound is usable as the radical polymerizable compound (C) without any limitation. Specific examples of the radical polymerizable compound (C) include acryloylmorpholine (SP value: 22.9), N-methoxymethylacrylamide (SP value: 22.9), and N-ethoxymethylacrylamide (SP value: 22.3). As the radical polymerizable compound (C), a commercially available product is also suitably usable. Examples thereof include ACMO (manufactured by KOHJIN Film & Chemicals Co., Ltd.; SP value: 22.9), WASMER 2MA (manufactured by Kasano Kosan Corp.; SP value: 22.9), WASMER EMA (manufactured by Kasano Kosan Corp.; SP value: 22.3), and WASMER 3MA (manufactured by Kasano Kosan Corp.; SP value: 22.4).

When the glass transition temperature (Tg) of a homopolymer of each of the radical polymerizable compounds (A), (B) and (C) is 60° C. or higher, the Tg of the adhesive layer also becomes high to become particularly good in endurance. As a result, when the adhesive composition is formed into, for example, an adhesive layer for a polarizer and a transparent protective film, the generation of a heat shock crack can be prevented in the polarizer. The Tg of the homopolymer of the radical polymerizable compounds means the Tg (of a polymer obtained) when the radical polymerizable compound is cured (polymerized) alone. A method for measuring the Tg will be described later.

The active-energy-ray-curable adhesive composition according to the present invention contains the radical polymerizable compounds (A), (B) and (C) in a total amount of 85 to 100 parts by weight, and may further contain a radical polymerizable compound (D) having an SP value of more than 23.0 (kJ/m³)^{1/2}, and less than 29.0 (kJ/m³)^{1/2} in an amount of 0 to 15 parts by weight. Specific examples of the radical polymerizable compound (D) include 4-hydroxybutyl acrylate (SP value: 23.8), 2-hydroxyethyl acrylate (SP value: 25.5), N-vinylcaprolactam (trade name: V-CAP, manufactured by ISP Ltd.; SP value: 23.4), and 2-hydroxypropyl acrylate (SP value: 24.5).

When the active-energy-ray-curable adhesive composition according to the present invention is used as an electron-beam-curable form, it is not particularly necessary to incorporate a photopolymerization initiator into the composition. When the composition is used as an ultraviolet-curable form, it is preferred to use a photopolymerization initiator. It is particularly preferred to use a photopolymerization initiator having a high sensitivity to a light ray having a wavelength of 380 nm or more. The photopolymerization initiator, which has a high sensitivity to a light ray having a wavelength of 380 nm or more, will be described later.

In the active-energy-ray-curable adhesive composition according to the present invention, it is preferred to use, as a photopolymerization initiator, only a compound represented by the following general formula (1):

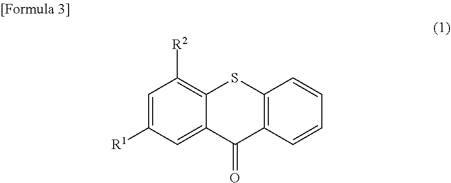

wherein R¹ and R² each represent —H, —CH₂CH₃, -iPr or Cl, and may be the same or different; or use the compound represented by the general formula (1) together with a photopolymerization initiator described later, which has a high sensitivity to a light ray having a wavelength of 380 nm or more. When the compound represented by the general formula (1) is used, the adhesive layer is better in adhesive property than when the photopolymerization initiator having a high sensitivity to a light ray having a wavelength of 380 nm or more is used alone. Among compounds represented by the general formula (1), particularly preferred is diethylthioxanthone, wherein R¹ and R² are each —CH₂CH₃. The composition proportion of the compound represented by the general formula (1) in the composition is preferably from 0.1 to 5.0% by weight, more preferably from 0.5 to 4.0% by weight, even more preferably from 0.9 to 3.0% by weight when the total amount of the composition is regarded as 100% by weight.

It is also preferred to add, thereto, a polymerization initiation aid as needed. Examples of the polymerization initiator aid include triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate. Particularly preferred is ethyl 4-dimethylaminobenzoate. When the polymerization initiation aid is used, the addition amount thereof is usually from 0 to 5% by weight, preferably from 0 to 4% by weight, most preferably from 0 to 3% by weight, when the total amount of the composition is regarded as 100% by weight.

As needed, a known photopolymerization initiator may be also used together. Since a transparent protective film having UV absorption capability does not transmit any light ray having a wavelength of 380 nm or less, it is preferred to use, as the photopolymerization initiator, a photopolymerization initiator having a high sensitivity to a light ray having a wavelength of 380 nm or more. Specific examples thereof include 2-methyl-1-(4-methylthiophenyl)-2-morpholinopropane-1-one, 2-benzyl-2-dimethylamino-1-(4-morpholinophenyl)-butanone-1,2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, and bis(η5-2,4-cyclopentadiene-1-yl)-bis(2,6-difluoro-3-(1H-pyrrole-1-yl)-phenyl)titanium.

It is particularly preferred to use, as the photopolymerization initiator, a compound represented by the following general formula (2) together with the photopolymerization initiator of the general formula (1):

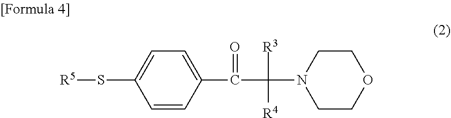

wherein R³, R⁴ and R⁵ each represent —H, —CH₃, —CH₂CH₃, -iPr or Cl, and may be the same or different. As the compound represented by the general formula (2), a commercially available product, i.e., 2-methyl-1-(4-methylthiophenyl)-2-morpholinopropane-1-one (trade name: IRGACURE 907; maker: BASF), may be suitably used. Besides the compound, the following compounds are preferred since the compounds are high in sensitivity: 2-benzyl-2-dimethylamino-1-(4-morpholinophenyl)-butanone-1 (trade name: IRGACURE 369; maker: BASF), and 2-(dimethylamino)-2-[(4-methylphenyl)methyl]-1-[4-(4-morpholinyl)phenyl]-1-butanone (trade name: IRGACURE 379; maker: BASF).

Various additives may be blended, as additional optional components, into the active-energy-ray-curable adhesive composition according to the present invention, as long as the object and the advantageous effects of the present invention are not damaged. Examples of the additives include polymers or oligomers such as epoxy resin, polyamide, polyamideimide, polyurethane, polybutadiene, polychloroprene, polyether, polyester, styrene-butadiene block copolymer, petroleum resin, xylene resin, ketone resin, cellulose resin, fluorine-contained oligomer, silicone oligomer, and polysulfide oligomer; polymerization inhibitors such as phenothiazine, and 2,6-di-t-butyl-4-methylphenol; polymerization initiation aids; leveling agents; wettability improvers; surfactants; plasticizers; ultraviolet absorbers; silane coupling agents; inorganic fillers; pigments; and dyes.

Among the above-mentioned additives, silane coupling agents may act onto the front surface of a polarizer to give a larger water resistance thereto. When one or more silane coupling agents are used, the addition amount thereof is usually from 0 to 10% by weight, preferably from 0 to 5% by weight, most preferably from 0 to 3% by weight, when the total amount of the composition is regarded as 100% by weight.

The silane coupling agent used is preferably an active-energy-ray-curable compound. However, even when the agent is not any active-energy-ray-curable compound, substantially the same or similar water resistance can be given.

Specific examples of the silane coupling agent include vinyltrichlorosilane, vinyltrimethoxysilane, vinyltriethoxysilane, 2-(3,4 epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane as active-energy-ray-curable compounds.

Specific examples of the silane coupling agent that is not active-energy-ray-curable include N-2(aminoethyl)-3-aminopropylmethyldimethoxysilane, N-2(aminoethyl)-3-aminopropyltrimethoxysilane, N-2(aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, hydrochloride of N-(vinylbenzyl)-2-aminoethyl-3-aminopropyltrimethoxysilane, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, and imidazolesilane.

The silane coupling agent is preferably 3-methacryloxypropyltrimethoxysilane, or 3-acryloxypropyltrimethoxysilane.

The active-energy-ray-curable adhesive composition according to the present invention is usable in an electron-beam-curable form or an ultraviolet-curable form.

In the electron-beam-curable form, any appropriate conditions for radiating an electron beam may be adopted as long as the conditions enable to cure the active-energy-ray-curable adhesive composition. For example, in the radiation of an electron beam, the acceleration voltage is preferably from 5 to 300 kV, more preferably from to 250 kV. If the acceleration voltage is less than 5 kV, the electron beam may not reach the adhesive so that the adhesive may be insufficiently cured. If the acceleration voltage is more than 300 kV, the beam may be too strong in penetration force into a sample to damage the transparent protective film or polarizer. The radiation dose is from 5 to 100 kGy, more preferably from to 75 kGy. If the radiation dose is less than 5 kGy, the adhesive is insufficiently cured. If the radiation dose is more than 100 kGy, the beam damages the transparent protective film or polarizer so that the film or polarizer is lowered in mechanical strength or is yellowed not to gain predetermined optical properties.

The electron beam radiation is usually conducted in an inert gas. If necessary, the radiation may be conducted in the atmosphere, or under a condition that a small volume of oxygen is introduced into the gas. By introducing oxygen appropriately thereinto, oxygen blocking dares to be caused in the transparent protective film surface onto which the electron beam first hits, so that a damage into the transparent protective film can be prevented although whether or not this method should be performed depends on the material of the transparent protective film. Thus, the electron beam can be effectively radiated only to the adhesive.

In the case of using, in the ultraviolet-curable form, a transparent protective film to which ultraviolet absorption capability is given, the film absorbs light rays having shorter wavelengths than 380 nm so that the light rays having shorter wavelengths than 380 nm do not reach the active-energy-ray-curable adhesive composition, and therefore do not contribute to a polymerization reaction thereof. Furthermore, the light rays absorbed in the transparent protective film, which have shorter wavelengths than 380 nm, are converted into heat so that the transparent protective film itself generates heat. The heat causes some defect such as curling and creases of the polarizing plate. Thus, when the ultraviolet-curable form is adopted in the present invention, it is preferred to use, as an ultraviolet generating device, a device which does not emit any light ray having shorter wavelength than 380 nm. More specifically, the ratio of the accumulated irradiance in a wavelength range of 380 to 440 nm to that in a wavelength range of 250 to 370 is preferably from 100:0 to 100:50, more preferably from 100:0 to 100:40. For ultraviolet rays satisfying such an accumulated irradiance relationship, preferred is a metal halide lamp into which gallium is sealed, or an LED light source emitting light rays having a wavelength range of 380 to 440 nm. Alternatively, it is allowable to use, as a light source, a low-pressure mercury lamp, a middle-pressure mercury lamp, a high-pressure mercury lamp, a superhigh-pressure mercury lamp, an incandescent lamp, a xenon lamp, a halogen lamp, a carbon arc lamp, a metal halide lamp, a fluorescent lamp, a tungsten lamp, a gallium lamp, an excimer laser, or sunlight provided that a band pass filter is used to shield light rays having wavelengths shorter than 380 nm.

In the ultraviolet-curable form, it is preferred to warm the active-energy-ray-curable adhesive composition before ultraviolet rays are radiated thereto (warming before radiation). In this case, the composition is warmed preferably to 40° C. or higher, more preferably to 50° C. or higher. It is also preferred to warm the active-energy-ray-curable adhesive composition after the ultraviolet rays are radiated thereto (warming after radiation). In this case, the composition is warmed preferably to 40° C. or higher, more preferably to 50° C. or higher.

The active-energy-ray-curable adhesive composition according to the present invention is suitably usable, particularly, for forming an adhesive layer for bonding a polarizer and a transparent protective film showing a transmittance less than 5% to a light ray having a wavelength of 365 nm. Here, the active-energy-ray-curable adhesive composition according to the present invention contains the photopolymerization initiator of the general formula (1) as described above to make it possible that when ultraviolet rays are radiated across a transparent protective film having UV absorption capability onto the composition, the adhesive layer is cured/formed. Thus, also in a polarizing plate in which transparent protective films having UV absorption capability are laminated on both surfaces of a polarizer, respectively, its adhesive layer can be cured. However, also in a polarizing plate in which a transparent protective film having no UV absorption capability is laminated on a polarizer, its adhesive layer can be naturally cured. The transparent protective film herein having UV absorption capability means a transparent protective film showing a transmittance less than 10% to a light ray having a wavelength of 380 nm.

Examples of the method for giving UV absorption capability to the transparent protective film include a method of incorporating an ultraviolet absorbent into the transparent protective film, and a method of laminating a surface treatment layer containing an ultraviolet absorbent onto a surface of the transparent protective film.

Specific examples of the ultraviolet absorbent include oxybenzophenone compounds, benzotriazole compounds, salicylate compounds, benzophenone compounds, cyanoacrylate compounds, nickel complex compounds, and triazine compounds each known in the prior art.

The adhesive layer made of the active-energy-ray-curable adhesive composition is higher in endurance than water-based adhesive layers. In the present invention, the adhesive layer used is preferably an adhesive layer having a Tg of 60° C. or higher. The thickness of the adhesive layer is preferably controlled into the range of 0.01 to 7 μm. In the case of using, in the polarizing plate of the present invention, the active-energy-ray-curable adhesive composition which is to form an adhesive layer having a Tg of 60° C. or higher, and further controlling the thickness of the adhesive layer into the range as described herein, the polarizing plate can satisfy endurance against a severe environment high in humidity and high in temperature. When the endurance of the polarizing plate is considered, it is preferred particularly in the present invention that when the Tg (° C.) of the adhesive layer is defined as A and the thickness (μm) of the adhesive layer as B, the following numerical expression (1) is satisfied: A−12×B>58.

As described above, it is preferred that the active-energy-ray-curable adhesive composition is selected in such a manner that an adhesive layer resulting from this composition will have a Tg of 60° C. or higher. Further, the Tg is preferably 70° C. or higher, more preferably 75° C. or higher, even more preferably 100° C. or higher, even more preferably 120° C. or higher. However, if the Tg of the adhesive layer is too high, the flexibility of the polarizing plate is declined. Thus, the Tg of the adhesive layer is preferably 300° C. or lower, more preferably 240° C. or lower, even more preferably 180° C. or lower.

Also as described above, the thickness of the adhesive layer is preferably from 0.01 to 7 μm, more preferably from 0.01 to 5 μm, even more preferably from 0.01 to 2 μm, most preferably from 0.01 to 1 μm. If the thickness of the adhesive layer is less than 0.01 μm, the cohesive power of the adhering power itself cannot be obtained so that the adhesive layer may not gain adhering strength. Meanwhile, if the thickness of the adhesive layer is more than 7 μm, the polarizing plate cannot satisfy endurance.

The polarizing plate according to the present invention has a step of applying the active-energy-ray-curable adhesive composition onto a surface of a polarizer on which an adhesive layer is to be formed and/or a surface of a transparent protective film on which an adhesive layer is to be formed, and then bonding the polarizer and the transparent protective film onto each other, and a next step of curing the active-energy-ray-curable adhesive composition by radiating one or more active energy rays thereonto to form the adhesive layer.

Before applying the active-energy-ray-curable adhesive composition, the polarizer and the transparent protective film may be subjected to a surface modifying treatment. Specific examples of the treatment include corona treatment, plasma treatment, and saponifying treatment.

The means or manner for applying the active-energy-ray-curable adhesive composition may be appropriately selected in accordance with the viscosity of the composition, and a target thickness. Examples of applying means or manner include a reverse coater, a gravure coater (direct, reverse or offset coater), a bar reverse coater, a roll coater, a die coater, a bar coater, and a rod coater. A dipping manner or any other manner may be appropriately used for applying.

Through the thus applied adhesive, the polarizer and the transparent protective film are bonded onto each other. The bonding of the polarizer onto the transparent protective film may be attained by means of a roll laminator or the like.

After bonding the polarizer onto the transparent protective film, one or more active energy rays (such as an electron beam or ultraviolet rays) are radiated thereto to cure the active-energy-ray-curable adhesive composition. In this way, an adhesive layer is formed. The direction in which the active energy ray(s) (such as the electron beam or ultraviolet rays) is/are radiated may be any appropriate direction. Preferably, the ray(s) is/are radiated from the transparent protective film side (of the workpiece). When the ray(s) is/are radiated from the polarizer side thereof, the polarizer may be deteriorated by the active energy ray(s) (such as the electron beam or ultraviolet rays).

When the polarizing plate according to the present invention is produced in a continuous line, the line speed, which depends on the curing period of the adhesive, is preferably from 1 to 500 m/min, more preferably from 5 to 300 m/min, even more preferably from to 100 m/min. If the line speed is too small, the productivity is poor or a large damage is given to the transparent protective film so that the polarizing film cannot be produced with endurance against an endurance test and others. If the lines speed is too large, the adhesive is insufficiently cured so that a target adhesive property may not be gained.

For the polarizing plate of the present invention, a polarizer and a transparent protective film are bonded onto each other through an adhesive layer formed by a cured product layer of the active-energy-ray-curable adhesive composition, but an adhesion facilitating layer may be provided between the transparent protective film and the adhesive layer. The adhesion facilitating layer may be made of a resin that may be of various types, respectively having polyester skeleton, polyether skeleton, polycarbonate skeleton, polyurethane skeleton, silicone base, polyamide skeleton, polyimide skeleton, polyvinyl alcohol skeleton or the like. These polymer resins may be used alone or in combination of two or more thereof. At the time of forming the adhesion facilitating layer, other additives may be added thereto. Specific examples thereof include a tackifier, an ultraviolet absorbent, an antioxidant, and stabilizers such as a heat-resistant stabilizer.

Usually, the adhesion facilitating layer is beforehand laid onto a transparent protective film, and a polarizer is bonded onto the adhesion facilitating layer side surface of the transparent protective film through the adhesive layer. The adhesion facilitating layer is formed by applying a forming-material of the adhesion facilitating layer onto the transparent protective film, and then drying the workpiece by a known technique. The forming-material of the adhesion facilitating layer is usually prepared in the form of a solution in which the material is diluted into an appropriate concentration, considering the dry thickness of the material, the smoothness of applying, and others. The dry thickness of the adhesion facilitating layer is preferably from 0.01 to 5 μm, more preferably from 0.02 to 2 μm, even more preferably from 0.05 to 1 μm. Plural adhesion facilitating layers may be laid. Also in this case, the total thickness of the adhesion facilitating layers is preferably adjusted into the above-mentioned range.

In the polarizing plate of the present invention, a transparent protective film is bonded onto at least one surface of a polarizer through an adhesive layer formed by a cured product layer of the above-mentioned active-energy-ray-curable adhesive composition.

The polarizer is not particularly limited, and may be of various types. The polarizer is, for example, one obtained by adsorbing a dichroic material such as iodine or a dichroic dye onto a hydrophilic polymer film, such as a polyvinyl alcohol based film, a partially formalized polyvinyl alcohol based film or an ethylene/vinyl acetate copolymer partially saponified film, and then drawing the film monoaxially; or a polyene-aligned film made of, for example, a polyvinyl-alcohol dehydrated product or a polyvinyl-chloride dehydrochloride-treated product. Among such films, preferred is a polarizer composed of a polyvinyl alcohol based film and a dichroic substance such as iodine. The thickness of such a polarizer is not particularly limited, and is generally about 80 μm or less.

The polarizer obtained by dyeing a polyvinyl alcohol based film with iodine and then drawing the film monoaxially may be formed, for example, by immersing polyvinyl alcohol in an aqueous solution of iodine so as to be dyed, and then drawing the film into a length being 3 to 7 times the original length. If necessary, the film may be immersed in an aqueous solution of boric acid, potassium iodide or some other. Further as needed, before the dyeing, the polyvinyl alcohol based film may be further immersed in water to be washed. The washing of the polyvinyl alcohol based film with water makes it possible to clean off stains or a blocking inhibitor on surfaces of the polyvinyl alcohol based film, and further causes the polyvinyl alcohol based film to be swelled, thus producing an advantageous effect of preventing an unevenness in the dyed color or some other unevenness. The drawing may be performed after, while or before the dyeing with iodine is performed. The drawing may be performed in an aqueous solution of boric acid, potassium iodide or some other or in a water bath.

The polarizer used may be a thin type polarizer having a thickness of 10 μm or less. From the viewpoint of making the polarizer thinner, the thickness is preferably from 1 to 7 μm. Such a thin type polarizer is preferred since the polarizer is small in thickness unevenness, excellent in visibility, and small in dimension change to be excellent in endurance, further allowing the thickness as a polarizing plate to be smaller.

Typical examples of the thin type polarizer include thin type polarizing films described in publications of JP-A-51-069644 and JP-A-2000-338329, the pamphlet of WO2010/100917, the specification of PCT/JP2010/001460, and specifications of Japanese Patent Applications No. 2010-269002 and No. 2010-263692. These thin type polarizing films can be obtained by a producing method including the step of drawing a polyvinyl alcohol based resin (hereinafter, also referred to as a PVA based resin) layer and a resin substrate for drawing in the state that these are laminated on each other, and the step of dyeing the resultant laminate. According to this producing method, the PVA based resin layer can be drawn without causing inconveniences by the drawing, such as breaking, even when the PVA based resin layer is thin, because the PVA based resin layer is supported by the resin substrate for drawing.

Among thin type polarizing films as described above, which are obtained by the method including the step of drawing in the state of a laminate and the step of dyeing the laminate, preferred is one obtained by a method including a step of drawing such a laminate in an aqueous boric acid solution, as described in the pamphlet of WO 2010/100917, or the specification of PCT/JP2010/001460 or Japanese Patent Application No. 2010-269002 or 2010-263692, since the laminate can be drawn into a high draw ratio and improved in polarizing performance. Particularly preferred is a polarizing film obtained by the method described in the specification of Japanese Patent Application No. 2010-269002 or 2010-263692, which includes the step of drawing such a laminate subsidiarily in the air before the laminate is drawn in an aqueous boric acid solution.

A thin type highly-functional polarizing film described in the specification of PCT/JP2010/001460, which is unified with a resin substrate so as to be produced is a thin type highly-functional polarizing film made of a PVA based resin in which a dichroic material is aligned and having a thickness of 7 μm or less. The film has optical properties such as a simplicial transmittance of 42.0% or more, and a polarization degree of 99.95% or more.

The thin type highly-functional polarizing film can be produced by applying a PVA based resin onto a resin substrate having a thickness of at least 20 μm and then drying the resultant workpiece to produce a PVA based resin layer; immersing the produced PVA based resin layer in a dyeing liquid of a dichroic material to adsorb the dichroic material onto the PVA based resin layer; and then drawing the dichroic-material-adsorbed PVA based resin layer unified with the resin substrate in an aqueous boric acid solution so as to give a total length being 5 times the original length or longer.

The thin type highly-functional polarizing film can be produced by a method for producing a laminate film containing a thin type highly-functional polarizing film in which a dichroic material is aligned, this method including the step of producing a laminated film including a resin substrate having a thickness of at least 20 μm, and a PVA based resin layer formed by applying an aqueous solution containing a PVA based resin onto a single surface of the resin substrate and then drying the workpiece; the step of immersing, into a dichroic-material-containing dyeing liquid, the laminated film, which includes the resin substrate and the PVA based resin layer formed on the single surface of the resin substrate, to adsorb the dichroic material onto the PVA based resin layer included in the laminated film; and the step of drawing the laminated film, which includes the dichroic-material-adsorbed PVA based resin layer, in an aqueous boric acid solution so as to give a total length being 5 times the original length or longer; and the step of forming, through the drawing of the dichroic-material-adsorbed PVA based resin layer unified with the resin substrate, a laminate film in which the following polarizing film is formed on the single surface of the resin substrate: a thin type highly-functional polarizing film made of the dichroic-material-aligned PVA based resin layer, having a thickness of 7 μm or less and optical properties that the simplicial transmittance is 42.0% or more and the polarization degree is 99.95% or more.

The thin type polarizing film described in the specification of Japanese Patent Application No. 2010-269002 or 2010-263692 is a continuous-web-form polarizing film made of a PVA based resin in which a dichroic material is aligned, and is also a film the thickness of which is set to 20 μm or less by drawing a laminate including a PVA based resin layer formed on an amorphous ester thermoplastic resin substrate through a two-stage drawing step of subsidiary drawing in the air and drawing in an aqueous boric acid solution. This thin type polarizing film is preferably one formed to have optical properties satisfying the following: P>−(100.929T−42.4−1)××100 wherein T<42.3, and P≧99.9 wherein T≧42.3 when the simplicial transmittance of the film is represented by T and the polarization degree thereof is represented by P.

Specifically, this thin type polarizing film can be produced by a method for producing a thin type polarizing film, including the step of drawing, at high temperature in the air, a PVA based resin layer formed on an amorphous ester thermoplastic resin substrate in a continuous web form to produce a drawn intermediate product made of the PVA based resin layer aligned, the step of adsorbing a dichroic material (preferably, iodine or a mixture of iodine and an organic dye) onto the drawn intermediate product to produce a colored intermediate product made of the dichroic-material-aligned PVA based resin layer, and the step of drawing the colored intermediate product in an aqueous boric acid solution to produce a polarizing film made of the dichroic-material-aligned PVA based resin layer and having a thickness of 10 μm or less.

In this producing method, it is desired to adjust, into 5 times or more, the total draw ratio of the PVA based resin layer formed on the amorphous ester thermoplastic resin substrate by the high-temperature drawing in the air and the drawing in the aqueous boric acid solution. The liquid temperature of the aqueous boric acid solution for the drawing in this aqueous boric acid solution may be set to 60° C. or higher. Before the drawing of the colored intermediate product in the aqueous boric acid solution, this product is desirably subjected to insolubilization treatment. In this case, it is desired to conduct the treatment by immersing the colored intermediate product into the aqueous boric acid solution having a liquid temperature lower than 40° C. The amorphous ester thermoplastic resin substrate may be made of an isophthalic-acid-copolymerized polyethylene terephthalate copolymer, a cyclohexanedimethanol-copolymerized polyethylene terephthalate copolymer, or an amorphous polyethylene terephthalate containing other polyethylene terephthalate copolymer, and is preferably made of a transparent resin. The thickness thereof may be made at least 7 times larger than the thickness of the formed PVA based resin layer. The draw ratio in the high-temperature drawing in the air is preferably 3.5 or less. The drawing temperature for the high-temperature drawing in the air is preferably the glass transition temperature of the PVA based resin or higher, and specifically ranges from 95 to 150° C. When the high-temperature drawing in the air is conducted in a free-end monoaxial drawing manner, the total draw ratio of the PVA based resin formed on the amorphous ester thermoplastic resin substrate is preferably from 5 to 7.5 both inclusive. When the high-temperature drawing in the air is conducted in a fixed-end monoaxial drawing manner, the total draw ratio of the PVA based resin formed on the amorphous ester thermoplastic resin substrate is preferably from 5 to 8.5 both inclusive.

More specifically, the thin type polarizing film can be produced by a method as described in the following:

A substrate in a continuous web form is produced which is made of an isophthalic-acid-copolymerized polyethylene terephthalate (amorphous PET) in which the proportion of isophthalic acid is 6% by mole. The glass transition temperature of the amorphous PET is 75° C. A laminate composed of the continuous-web-form amorphous PET substrate and a polyvinyl alcohol (PVA) layer is formed as described below. For reference, the glass transition temperature of PVA is 80° C.

Prepared are the amorphous PET substrate, which has a thickness of 200 μm, and an aqueous PVA solution in which PVA powder having a polymerization degree of 1000 or more and a saponification degree of 99% or more is dissolved in water to give a concentration of 4 to 5%. Next, the aqueous PVA solution is applied onto the amorphous PET substrate of 200 μm thickness, and the workpiece is dried at a temperature of 50 to 60° C. to yield a laminate in which a PVA layer of 7 μm thickness is formed on the amorphous PET substrate.

The laminate containing the PVA layer of 7 μm thickness is caused to undergo a step detailed below, which includes a two-stage drawing step of subsidiary drawing in the air and drawing in an aqueous boric acid solution, to produce a thin type highly-functional polarizing film of 3 μm thickness. Through the step of the subsidiary drawing in the air at the first stage, the laminate containing the PVA layer of 7 μm thick and unified with the amorphous PET substrate is drawn to produce a drawn laminate containing a PVA layer of 5 μm thickness. Specifically, this drawn laminate is a laminate yielded by subjecting the laminate containing the PVA layer of 7 μm thickness to a drawing device located in an oven set in the drawing temperature environment of 130° C., and then drawing the laminate in a free-end monoaxial drawing manner so as to give a total draw ratio of 1.8. By this drawing treatment, the PVA layer contained in the drawn laminate is changed to a PVA layer of 5 μm thickness in which PVA molecules are aligned.

Next, through a dyeing step, iodine is adsorbed onto the PVA layer of 5 μm thickness, in which the PVA molecules are aligned, to produce a colored laminate. Specifically, this colored laminate is one yielded by immersing the drawn laminate in a dyeing liquid having a liquid temperature of 30° C. and containing iodine and potassium iodide for an arbitrary period in such a manner that a PVA layer constituting a finally-produced highly-functional polarizing film will have a simplicial transmittance of 40 to 44%, thereby adsorbing iodine onto the PVA layer contained in the drawn laminate. In the present step, the dyeing liquid contains water as a solvent. The concentration of iodine therein is set within the range of 0.12 to 0.30% by weight, and that of potassium iodide therein within the range of 0.7 to 2.1% by weight. The ratio by concentration of iodide to potassium iodide is 1 to 7. By the way, for dissolution of iodide in water, potassium iodide is necessary. In more detail, by immersing the drawn laminate in a dyeing liquid containing iodide in a concentration of 0.30% by weight and potassium iodide in a concentration of 2.1% by weight for 60 seconds, a colored laminate is produced in which iodide is adsorbed on the PVA layer of 5 μm thickness in which PVA molecules are aligned.

Furthermore, through the step of the drawing in an aqueous boric acid solution at the second stage, the colored laminate unified with the amorphous PET substrate is further drawn to produce an optical film laminate containing the PVA layer constituting a highly-functional polarizing film of 3 μm thickness. Specifically, this optical film laminate is one obtained as follows: the colored laminate is set into a drawing device located in a treatment system set in an aqueous boric acid solution containing boric acid and potassium iodide and having a liquid temperature ranging from 60 to 85° C., and then is drawn in a free-end monoaxial drawing manner so as to give a draw ratio of 3.3. In more detail, the liquid temperature of the aqueous boric acid solution is 65° C. Additionally, in the solution, the boric acid content is set to 4 parts by weight for 100 parts by weight of water, and the potassium iodide content to 5 parts by weight for 100 parts by weight of water. In the present step, the colored laminate, in which the amount of adsorbed iodide has been adjusted, is first immersed in an aqueous boric acid solution for 5 to 10 seconds. Thereafter, the colored laminate is fed as it is, and passed through a plurality of pairs of rolls being different in peripheral velocity, which are the drawing device located in the treatment system, and is drawn in a free-end monoaxial drawing manner over 30 to 90 seconds so as to give a draw ratio of 3.3. By this drawing treatment, the PVA layer contained in the colored laminate is changed to a PVA layer of 3 μm thickness in which adsorbed iodines are aligned in the form of a polyiodine ion complex, to a high degree in one direction. This PVA layer constitutes a highly-functional polarizing film of an optical film laminate.

A washing step, which is not an essential step for producing the optical film laminate, is preferably conducted, wherein the optical film laminate is taken out from the aqueous boric acid solution and then an aqueous solution of potassium iodide is used to wash off boric acid adhering to the front surface of the PVA layer of 3 μm thickness formed on the amorphous PET substrate. Thereafter, the washed optical film laminate is dried in a drying step with hot wind of 60° C. The washing step is a step for overcoming an external appearance defect, such as boric acid precipitation.

A bonding step and/or a transferring step, which is/are not also essential for producing the optical film laminate, may be conducted, in which, while an adhesive is applied onto the front surface of the PVA layer of 3 μm thickness formed on the amorphous PET substrate, a triacetylcellulose film of 80 μm thickness is bonded onto the surface, and subsequently the amorphous PET substrate is peeled off to permit the PVA layer of 3 μm thickness to be transferred onto the triacetylcellulose film of 80 μm thickness.

### [Other Steps]

The method for producing the thin type polarizing film may include, in addition to the above-mentioned steps, other steps. Examples of the other steps include an insolubilization step, a crosslinking step, and a drying (water-content-by-percentage adjusting) step. The other steps may each be conducted at any appropriate timing.

Typically, the insolubilization step is conducted by immersing the PVA based resin layer in an aqueous boric acid solution. By conducting the insolubilization treatment, water resistance can be given to the PVA based resin layer. The concentration of the aqueous boric acid solution is preferably from 1 to 4 parts by weight for 100 parts by weight of water. The liquid temperature of the insolubilization bath (aqueous boric acid solution) is preferably from to 50° C. Preferably, the insolubilization step is conducted after the production of the laminate and before the dyeing step and the drawing step in the aqueous solution.

Typically, the crosslinking step is conducted by immersing the PVA based resin layer in an aqueous boric acid solution. By conducting the crosslinking treatment, water resistance can be given to the PVA based resin layer. The concentration of the aqueous boric acid solution is preferably from 1 to 4 parts by weight for 100 parts by weight of water. When the crosslinking step is conducted after the dyeing step, it is preferred to blend an iodide into the aqueous solution. By the blending of the iodide, the elution-out of iodide adsorbed on the PVA based resin layer can be suppressed. The blend amount of the iodide is preferably from 1 to 5 parts by weight for 100 parts by weight of water. A specific example of the iodide is as described above. The liquid temperature of the crosslinking bath (aqueous boric acid solution) is preferably from 20 to 50° C. Preferably, the crosslinking step is conducted before the second-stage drawing step in the aqueous boric acid solution. In a preferred embodiment, the dyeing step, the crosslinking step, and the second-stage drawing step in the aqueous boric acid solution are conducted in this order.

The material of the transparent protective film provided over one or both surfaces of the polarizer is preferably a material excellent in transparency, mechanical strength, thermal stability, water blocking performance, isotropy, and others. Examples thereof include polyester based polymers such as polyethylene terephthalate and polyethylene naphthalate; cellulose based polymers such as diacetylcellulose and triacetylcellulose; acryl-based polymers such as polymethyl methacrylate; styrene based polymers such as polystyrene and acrylonitrile/styrene copolymer (AS resin); and polycarbonate based polymers. Other examples thereof include polyolefin based polymers such as polyethylene, polypropylene, any polyolefin having a cyclic structure or a norbornene structure, and ethylene/propylene copolymer; vinyl chloride based polymers; amide based polymers such as nylon and aromatic polyamide; imide based polymers; sulfone based polymers; polyethersulfone based polymers; polyetheretherketone based polymers; polyphenylenesulfide based polymers; vinyl alcohol based polymers; vinylidene chloride based polymers; vinyl butyral based polymers; acryl-based polymers; polyoxymethylene based polymers; epoxy based polymers; and any blend of two or more of these polymers. The transparent protective film may contain one or more arbitrary appropriate additives. Examples of the additives include an ultraviolet absorbent, an antioxidant, a lubricant, a plasticizer, a release agent, a coloring inhibitor, a frame retardant, a nucleating agent, an antistatic agent, a pigment and a colorant. The content by percentage of the above-mentioned thermoplastic resin(s) in the transparent protective film is preferably from 50 to 100% by weight, more preferably from 50 to 99% by weight, even more preferably from 60 to 98% by weight, in particular preferably from 70 to 97% by weight. If the content by percentage of the thermoplastic resin(s) in the transparent protective film is 50% or less by weight, it is feared that a high transparency and other advantages that the thermoplastic resin(s) originally has/have are not sufficiently exhibited.

The transparent protective film may be a polymer film described in JP-A-2001-343529 (WO01/37007), for example, a resin composition containing a thermoplastic resin (A) having, at its side chain, a substituted and/or unsubstituted imide group, and a thermoplastic resin (B) having, at its side chain, a substituted and/or unsubstituted phenyl, and a nitrile group. A specific example thereof is a film made of a resin composition containing an alternating copolymer made from isobutylene and N-methylmaleimide, and an acrylonitrile/styrene copolymer. As the film, a film that is made of, for example, a mixed extruded product of the resin composition may be used. Such a film is small in retardation and optical elastic coefficient to make it possible to overcome an unevenness and other inconveniences based on a strain of the polarizing plate. The film is also small in moisture permeability to be excellent in humidification endurance.

The thickness of the transparent protective film may be appropriately decided, and is generally from about 1 to 500 μm from the viewpoint of, for example, the strength, the handleability and other workabilities, and the thin layer property of the film. The thickness is in particular preferably from 1 to 300 μm, more preferably from 5 to 200 μm.

When such transparent protective films are provided on both the sides of the polarizer, respectively, the films may be films made of the same polymer material, or films made of different polymer materials or the like on the front and rear surfaces.

A functional layer, such as a hard coat layer, antireflective layer, sticking preventing layer, diffusion layer or anti-glare layer, may be provided on the surface of the transparent protective film(s) onto which no polarizer is bonded. The functional layer, such as the hard coat layer, antireflective layer, sticking preventing layer, diffusion layer or anti-glare layer, may be provided on the transparent protective film itself, or separately provided in the form of a member separated from the transparent protective film.

When practically used, the polarizing plate of the present invention may be used as an optical film which is laminated thereon with any other optical layer(s). The optical layer is not particularly limited, and may be an optical layer usable to form a liquid crystal display device. The optical layer is, for example, a reflector, a semi-transmissible plate, a retardation plate, which may be a wavelength plate such as a half wavelength plate or quarter wavelength plate, or a viewing angle compensation film and may be used in the form of one layer or two or more layers. The polarizing plate is in particular preferably a reflective polarizing plate or semi-transmissible polarizing plate in which a reflector or a semi-transmissible reflector is further laminated on the polarizing plate of the present invention; an elliptically polarizing plate or circularly polarizing plate in which a retardation plate is further laminated on the polarizing plate; a wide viewing angle polarizing plate in which a viewing angle compensation film is further laminated on the polarizing plate; or a polarizing plate in which a brightness enhancement film is further laminated on the polarizing plate.

An optical film in which optical layers as described above are laminated on the polarizing plate may be formed in the manner of laminating the layers independently and successively in a process for producing, for example, a liquid crystal display device. An optical film obtained, as an independent article, by laminating the layers beforehand is excellent in quality stability, fabricating workability and others to have an advantage of improving a process for producing, for example, a liquid crystal display device. For the laminating, an appropriate bonding means or member, such as a pressure-sensitive adhesive layer, is usable. When a polarizing plate as described above or any other optical film is bonded, the optical axis thereof may be set to an appropriate configuration angle in accordance with a target retardation property, or others.

A polarizing plate as described above, or an optical film in which such a polarizing plate or polarizing plates is/are laminated may be provided with a pressure-sensitive adhesive layer in order to be bonded onto a different member such as a liquid crystal cell. A pressure-sensitive adhesive for forming the pressure-sensitive adhesive layer is not particularly limited, and may be appropriately selected for use, from materials each containing, as a base polymer, acryl-based polymer, silicone based polymer, polyester, polyurethane, polyamide, polyether, fluorine-contained polymer or rubbery polymer. It is particularly preferred to use an acryl-based pressure-sensitive adhesive and the like that is excellent in optical transparency and shows appropriate pressure-sensitive adhesive properties such as wettability, cohesive property and adhesive property to be excellent in weather resistance, heat resistance and others.

The pressure-sensitive adhesive layer may be laid, in the form of laminated layers different from each other in composition, kind or some other, on one or both surfaces of the polarizing plate or optical film. In the case of providing the pressure-sensitive adhesive layers on both surfaces, the layers may be pressure-sensitive adhesive layers different from each other in composition, kind, thickness or some other on the front and rear surfaces of the polarizing plate or optical film. The thickness of the pressure-sensitive adhesive layer(s) may be appropriately determined in accordance with a purpose of the use, the pressure-sensitive adhering power and others, and is generally from 1 to 500 μm, preferably from 1 to 200 μm, in particular preferably from 1 to 100 μm.

The exposed surface of the pressure-sensitive adhesive layer is covered with a separator bonded temporarily to the surface for the prevention of contamination, and others until practically used. In this way, contacting with the pressure-sensitive adhesive layer(s) can be prevented in the state of ordinary handling. As the separator, except the above-mentioned thickness requirement, any appropriate conventional separator may be used, for example, appropriate sheet-like body such as a plastic film, a sheet of rubber, paper, cloth, nonwoven fabric, net, a foamed sheet, a metal foil, or a laminate composed thereof, which may be optionally subjected to coating treatment with an appropriate release agent such as a silicone based agent, a long-chain alkyl based agent, a fluorine-contained compound, or molybdenum sulfide.

The polarizing plate or optical film of the present invention is preferably usable to form a liquid crystal display device, or any other device. The liquid crystal display device may be formed in accordance with a conventional method. Specifically, a liquid crystal display device is formed, for example, by fabricating appropriately constituting-members, such as a liquid crystal cell, a polarizing plate or optical film, and an optical lighting system, and then integrating a driving circuit thereinto; in the present invention, a liquid crystal display device may be formed in accordance with this conventional method without any especial limitation except that the polarizing plate or optical film according to the present invention is used. The liquid crystal cell used may be of any type, such as a TN, STN, or π type.

Any appropriate liquid crystal display device, such as a liquid crystal display device in which one or more polarizing plates or optical films are arranged on one or both sides of a liquid crystal cell, or a display device in which a backlight or reflector is further used for a lighting system may be formed. In this case, polarizing plates or optical films according to the present invention may be arranged on one or both sides of the liquid crystal cell, respectively. When the polarizing plates or optical films are arranged on both the sides, these may be the same or different. Furthermore, when the liquid crystal display device is formed, one or more appropriate members, such as a diffusion plate, an anti-glare layer, an antireflective film, a protective plate, a prism array, a lens array sheet, a light diffusion plate or a backlight, may be arranged in the form of one or more layers at one or more appropriate positions.

### EXAMPLES

Hereinafter, working examples of the present invention will be described. However, embodiments of the present invention are not limited by these examples.

### <Tg: Glass Transition Temperature>

The Tg was measured using a dynamic viscoelasticity measuring instrument RSAIII manufactured by TA Instrument, Inc. under the following measuring conditions:

Sample size: a width of 10 mm, and a length of 30 mm,

Clamp distance: 20 mm,

Measuring mode: tensile mode, Frequency: 1 Hz, and Temperature-raising rate: 5° C./minute.

The dynamic viscoelasticity was measured, and the peak top temperature of the tan δ was adopted as the Tg.

### <Polarizer X>

A polyvinyl alcohol film having an average polymerization degree of 2400, a saponification degree of 99.9% by mole and a thickness of 75 μm was immersed in warm water at 30° C. for 60 seconds to be swelled. Next, the film was immersed in an aqueous solution of iodine/potassium iodide (ratio by weight: 0.5/8) having the concentration of 0.3% to be dyed while the film was drawn into a draw ratio of 3.5. Thereafter, the film was drawn into a total draw ratio of 6 in an aqueous borate solution at 65° C. After the drawing, the film was dried in an oven at 40° C. for 3 minutes to yield a PVA based polarizer X (SP value: 32.8, and thickness: 23 μm).

### <Transparent Protective Film>

As a transparent protective film, a triacetylcellulose film (TAC) (SP value: 23.3) of 80 μm thickness was used without being subjected to saponifying treatment, corona treatment nor any similar treatment (hereinafter, a TAC subjected to neither saponifying treatment, corona treatment nor any similar treatment may be referred to as an “untreated TAC”).

### <Active Energy Rays>

As active energy rays, ultraviolet rays (gallium-sealed metal halide lamp) were used (radiating device: Light HAMMER 10, manufactured by Fusion UV Systems, Inc.; valve: V valve; peak irradiance: 1600 mW/cm²; and accumulated radiation dose: 1000/mJ/cm² (wavelength: 380 to 440 nm)). The irradiance of the ultraviolet rays was measured using a Sola-Check system manufactured by Solatell Ltd.

### (Preparation of Active-Energy-Ray-Curable Adhesive Compositions)

### Examples 1 to 7, and Comparative Examples 1 to 5

An active-energy-ray-curable adhesive composition according to each of Examples 1 to 7 and Comparative Examples 1 to 5 was obtained by mixing individual components with each other at 50° C. for 1 hour in accordance with a blend table described in Table 2. The individual components used are as follows:

### (1) Radical Polymerizable Compounds (A)

HEAA (hydroxyethylacrylamide) manufactured by KOHJIN Film & Chemicals Co., Ltd., SP value: 29.6, and Tg of a homopolymer: 123° C., and

N-MAM-PC(N-methylolacrylamide) manufactured by Kasano Kosan Corp., SP value: 31.5, and Tg of a homopolymer: 150° C.,

### (2) Radical Polymerizable Compounds (B)

ARONIX M-220 (tripropylene glycol diacrylate) manufactured by Toagosei Co., Ltd., SP value: 19.0, and Tg of a homopolymer: 69° C., and

LIGHT ACRYLATE DCP-A (tricyclodecanedimethanol diacrylate) manufactured by Kyoeisha Chemical Co., Ltd., SP value: 20.3, and Tg of a homopolymer: 134° C.,

### (3) Radical Polymerizable Compounds (C)

ACMO (acryloylmorpholine), manufactured by KOHJIN Film & Chemicals Co., Ltd., SP value: 22.9, and Tg of a homopolymer: 150° C., and

WASMER 2MA (N-methoxymethylacrylamide) manufactured by Kasano Kosan Corp., SP value: 22.9, and Tg of a homopolymer: 99° C.,

### (4) Radical Polymerizable Compound (D)

4HBA (4-hydroxybutyl acrylate) manufactured by Osaka Organic Chemical Industry Ltd., SP value: 23.8, and Tg of a homopolymer: −14° C.,

### (5) Photopolymerization Initiators

KAYACURE DETX-S (diethylthioxanthone), manufactured by Nippon Kayaku Co., Ltd., and

IRGACURE 907 (2-methyl-1-(4-methylthiophenyl)-2-morpholinopropane-1-one), manufactured by BASF Co.

Next, the active-energy-ray-curable adhesive composition of each of Examples 1 to 7 and Comparative Examples 1 to 5 was applied on any one of the above-mentioned transparent protective films so as to have a thickness of 0.5 μm, using an MCD coater (manufactured by Fuji Machinery Co., Ltd.) (cell shape: honeycomb, the number of gravure roll lines: 1000/inch, and rotating speed: 140% of the line speed), and the resultant adhesive composition layer was bonded onto both the surfaces of the polarizer X through a roll machine. Thereafter, an IR heater was used to heat the workpiece to 50° C. from the transparent protective film sides (both sides) thereof. The above-mentioned ultraviolet rays were radiated onto both the sides to cure the active-energy-ray-curable adhesive composition of each of Examples 1 to 7 and Comparative Examples 1 to 5. Thereafter, the workpiece was dried with hot wind at 70° C. for 3 minutes to yield a polarizing plate having the transparent protective films on both sides of the polarizer, respectively. The line speed for the bonding was set to m/min. Each of the resultant polarizing plates was evaluated about an adhesive power (onto the TAC), a water resistance (according to a warm water immersion test), and an endurance (according to a heat shock test) under conditions described below.

### Example 8

### (Formation of a Thin Type Polarizing Film Y, and Formation of a Polarizing Plate Using the Film)

In order to form a thin type polarizing film Y, a laminate in which a PVA layer of 24 μm thickness was formed on an amorphous PET substrate was first drawn at a drawing temperature of 130° C. in a subsidiary drawing manner in the air to produce a drawn laminate. Next, the drawn laminate was dyed to produce a colored laminate. Furthermore, the colored laminate was drawn into a total draw ratio of 5.94 at a drawing temperature of 65° C. in a drawing manner in an aqueous boric acid solution to produce an optical film laminate including a PVA layer of 10 μm thickness drawn in the state of being unified with the amorphous PET substrate. By this two-stage drawing, PVA molecules in the PVA layer formed on the amorphous PET substrate were aligned in a high order. Thus, an optical film laminate was able to be produced which included the PVA layer of 10 μm thickness constituting a highly-functional polarizing film Y in which iodine adsorbed by the dyeing was aligned in a high order, as a polyiodine ion complex, in one direction. Furthermore, the active-energy-ray-curable adhesive composition according to Example 1 was applied onto the front surface of the thin type polarizing film Y of the optical film laminate. The same transparent protective film as used in Example 1 was bonded to the laminate from the adhesive-applied surface thereof, and then the amorphous PET substrate was peeled to produce a polarizing plate having the thin type polarizing film Y (polarizing plate according to Example 8).

### <Adhering Power>

The polarizing plate was cut into a size having a length of 200 mm parallel to the drawn direction of the polarizer and a width of 20 mm orthogonal thereto. A cutter knife was used to make a cut between the transparent protective film (untreated TAC; SP value: 23.3) and the polarizer (SP value: 32.8), and then the polarizing plate was bonded onto a glass plate. A TENSIRON was used to peel the protective film and the polarizer from each other into 90° directions at a peeling speed of 500 mm/min, and the peeling strength thereof was measured. After the peeling, an infrared absorption spectrum of the peel surface was measured by the ATR method. The peel interfaces were evaluated in accordance with the following criterion:

A: a cohesive failure of the protective film,

B: an interface peel between the protective film and the adhesive layer,

C: an interface peel between the adhesive layer and the polarizer, and

D: a cohesive failure of the polarizer.

In this criterion, A and D each denote that the adhering power is very good since the adhering power is larger than the cohesive power of the film. However, B and C denote that adhering power is insufficient (poor) in the protective film/adhesive layer (or adhesive layer/polarizer) interface. Considering these matters, the adhering power in any case of A or D is represented by a circular mark (goodness); that in any case of A×B (a “cohesive failure of the protective film” and an “interface peel between the protective film and the adhesive layer” are simultaneously generated), or A×C (a “cohesive failure of the protective film” and an “interface peel between the adhesive layer and the polarizer” are simultaneously generated) is represented by a triangular mark; and that in any case of B or C is represented by a cross mark (poorness).

### <Water Resistance (According to Warm Water Immersion Test>

The polarizing plate was cut into a rectangle having a length of 50 mm in the drawn direction of the polarizer and a width of 25 mm in the direction orthogonal thereto. This polarizing plate was immersed in warm water at 60° C. for 6 hours, and then a peel between the polarizer and the transparent protective film was visually observed. The water resistance thereof was evaluated in accordance with the following criterion:

◯: no peel is observed.

Δ: a peel is generated from its edge; however, no peel is observed at the center.

X: a peel is generated in the front surface.

### <Endurance (According to Heat Shock Test)>

A pressure-sensitive adhesive layer was laminated onto the acryl-based film surface of the polarizing plate, and the resultant was cut into a rectangle having a length of 200 mm in the drawn direction of the polarizer and a width of 400 mm in the direction orthogonal thereto. This polarizing plate was laminated on a glass plate, and the resultant sample was subjected to a heat cycle test in which heat cycles were each a cycle passing through temperatures of −40° C. and 85° C. After the sample underwent 50 cycles, the polarizing plate was visually observed. The endurance thereof was evaluated in accordance with the following criterion:

◯: no crack is observed.

Δ: the polarizer is cracked in the drawn direction thereof but the crack does not penetrate the polarizer (crack length: 200 mm or less).

x: the polarizer is cracked in the drawn direction thereof, and the crack penetrates the polarizer (crack length: 200 mm).

TABLE 2

| | Homopolymer | SP | Example | Example | Example | Example | Example | Example | Example |
|---|---|---|---|---|---|---|---|---|---|
| | Tg | value | 1 | 2 | 3 | 4 | 5 | 6 | 7 |
| (A) HEAA | 123° C. | 29.6 | 38.3 | 23.9 | 52.6 | 47.8 | 28.7 | 28.7 | 23.9 |
| (A) N-MAN-PC | 150° C. | 31.5 | — | — | — | — | — | 9.6 | 9.6 |
| (B) ARONIX M-220 | 69° C. | 19 | 19.1 | — | 14.4 | 23.9 | 14.4 | 19.1 | 19.1 |
| (B) LIGHT | 134° C. | 20.3 | — | 23.9 | — | — | — | — | — |
| ACRYLATE DCP-A | | | | | | | | | |
| (C) ACMO | 150° C. | 22.9 | 38.3 | 47.8 | 28.7 | 23.9 | 52.6 | — | — |
| (C) WASMER 2MA | 99° C. | 22.9 | — | — | — | — | — | 38.3 | 38.3 |
| 4HBA | −14° C. | 23.8 | — | — | — | — | — | — | 4.8 |
| KAYACURE | | | 1.4 | 1.4 | 1.4 | 1.4 | 1.4 | 1.4 | 1.4 |
| DETX-S | | | | | | | | | |
| IRGACURE 907 | | | 1.4 | 1.4 | 1.4 | 1.4 | 1.4 | 1.4 | 1.4 |

| | | | | | | | |
|---|---|---|---|---|---|---|---|
| Adhesive cured product Tg | 121 | 139 | 121 | 114 | 128 | 104 | 95 |
| TAC adhering power | ◯ | Δ | ◯ | Δ | ◯ | ◯ | ◯ |
| | (A) | (A-C) | (A) | (A-B) | (A) | (A) | (A) |
| Warm water immersion test | ◯ | ◯ | Δ | ◯ | Δ | ◯ | ◯ |
| Heat shock test | ◯ | ◯ | ◯ | ◯ | ◯ | ◯ | Δ |

| | Homopolymer | SP | Comparative | Comparative | Comparative | Comparative | Comparative |
|---|---|---|---|---|---|---|---|
| | Tg | value | Example 1 | Example 2 | Example 3 | Example 4 | Example 5 |
| (A) HEAA | 125° C. | 29.6 | 9.6 | 57.4 | 63.2 | 46.9 | 22.0 |
| (A) N-MAN-PC | 150° C. | 31.5 | — | — | — | — | — |
| (B) ARONIX M-220 | 69° C. | 19 | 28.7 | 28.7 | 9.6 | 5.7 | 9.6 |
| (B) LIGHT | 134° C. | 20.3 | — | — | — | — | — |
| ACRYLATE DCP-A | | | | | | | |
| (C) ACMO | 150° C. | 22.9 | 57.4 | 9.6 | 23.0 | 43.1 | 64.1 |
| (C) WASMER 2MA | 99° C. | 22.9 | — | — | — | — | — |
| 4HBA | −14° C. | 23.8 | — | — | — | — | — |
| KAYACURE | | | 1.4 | 1.4 | 1.4 | 1.4 | 1.4 |
| DETX-S | | | | | | | |
| IRGACURE 907 | | | 1.4 | 1.4 | 1.4 | 1.4 | 1.4 |

| | | | | | |
|---|---|---|---|---|---|
| Adhesive cured product Tg | 119 | 107 | 123 | 131 | 134 |
| TAC adhering power | X | X | Δ | ◯ | Δ |
| | (D) | (B) | (A-B) | (A) | (A-C) |
| Warm water immersion test | ◯ | ◯ | X | X | X |
| Heat shock test | ◯ | ◯ | ◯ | ◯ | ◯ |

TABLE 3

| | Example 8 |
|---|---|
| Adhesive composition | Example 1 |
| TAC adhering power | ◯ |
| | (A) |
| Warm water immersion test | ◯ |
| Heat shock test | ◯ |

From the results in Table 3, it is understood that even the polarizing plate obtained by using the thin type polarizing film Y of 10 μm thickness instead of the polarizer X of 23 μm thickness gives good results about the TAC adhering power, the warm water immersion test and the heat shock test.

1. An adhesive composition curable with an active energy ray, comprising radical polymerizable compounds (A), (B) and (C) as curable components; the composition comprising:
the radical polymerizable compound (A) having an SP value of 29.0 to 32.0 (kJ/m³)^{1/2} both inclusive in a proportion 20 of to 60% by weight,
the radical polymerizable compound (B) having an SP value of 18.0 (kJ/m³)^{1/2} or more, and less than 21.0 (kJ/m³)^{1/2} in a proportion of 10 to 30% by weight, and
the radical polymerizable compound (C) having an SP value of 21.0 to 23.0 (kJ/m³)^{1/2} both inclusive in a proportion of 20 to 60% by weight, when the total amount of the adhesive composition is regarded as 100% by weight;
wherein a homopolymer made from each of the radical polymerizable compounds (A), (B) and (C) has a glass transition temperature (Tg) of 60° C. or higher.

2. The adhesive composition curable with an active energy ray according to claim 1, wherein when the total amount of the radical polymerizable compounds in the adhesive composition is regarded as 100 parts by weight,
the radical polymerizable compounds (A), (B) and (C) are comprised in a total amount of 85 to 100 parts by weight, and further a radical polymerizable compound (D) having an SP value more than 23.0 (kJ/m³)^{1/2} and less than 29.0 (kJ/m)^{1/2} is comprised in an amount of 0 to 15 parts by weight.

3. The adhesive composition curable with an active energy ray according to claim 1, wherein the radical polymerizable compound (A) is hydroxyethylacrylamide and/or N-methylolacrylamide.

4. The adhesive composition curable with an active energy ray according to claim 1, wherein the radical polymerizable compound (B) is tripropylene glycol diacrylate.

5. The adhesive composition curable with an active energy ray according to claim 1, wherein the radical polymerizable compound (C) is acryloylmorpholine and/or N-methoxymethylacrylamide.

6. The adhesive composition curable with an active energy ray according to claim 1, comprising, as a photopolymerization initiator, a compound represented by the following general formula (1): 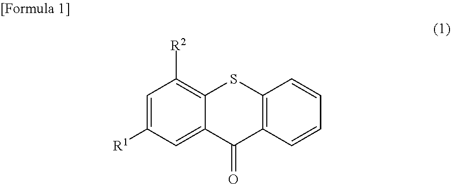
wherein R¹ and R² each represent —H, —CH₂CH₃, -iPr or Cl, and R¹ and R² may be the same or different.

7. The adhesive composition curable with an active energy ray according to claim 6, further comprising, as a photopolymerization initiator, a compound represented by the following general formula (2): 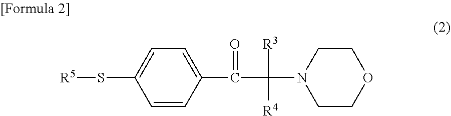
wherein R³, R⁴ and R⁵ each represent —H, —CH₃, —CH₂CH₃, -iPr or Cl, and R³, R⁴ and R⁵ may be the same or different.

8. A polarizing plate, comprising a polarizer, and a transparent protective film showing a transmittance less than 5% to a light ray having a wavelength of 365 nm and formed over at least one surface of the polarizer with an adhesive layer interposed between the polarizer and the transparent protective film,
wherein the adhesive layer is formed by a cured product layer obtained by radiating an active energy ray to the adhesive composition curable with an active energy ray according to claim 1.

9. The polarizing plate according to claim 8, wherein the transparent protective film has an SP value of 29.0 (kJ/m³)^{1/2} or more and less than 33.0 (kJ/m³)^{1/2}.

10. The polarizing plate according to claim 8, wherein the transparent protective film has an SP value of 18.0 (kJ/m³)^{1/2} or more and less than 24.0 (kJ/m³)^{1/2}.

11. The polarizing plate according to claim 8, wherein the adhesive layer has a glass transition temperature (Tg) of 60° C. or higher.

12. An optical film wherein one or more polarizing plates according claim 8 are laminated.

13. An image display device, comprising a polarizing plate according to claim 8.

14. An image display device, comprising an optical film according to claim 12.
